(19) United States
(12) Patent Application Publication
(10) Pub. No.: US 2009/0121475 A1
(43) Pub. Date: May 14, 2009

(54) DELIVERY PIPE FOR THE TRANSPORT OF SOLID MATERIAL, AND METHOD OF MAKING A DELIVERY PIPE

(75) Inventor: Alexander Esser, Warstein (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: ESSER-WERKE KG, 59581 Warstein (DE)

(21) Appl. No.: 11/577,848

(22) PCT Filed: Oct. 18, 2005
(86) PCT No.: PCT/EP05/11184

§ 371 Date: Apr. 24, 2007

(30) Foreign Application Priority Data
Oct. 28, 2004 (EP) 04025601.8

(51) Int. Cl. F16L 57/00

(52) U.S. Cl. 285/23

(57) ABSTRACT

A delivery pipe for transporting solid material has a tubular body provided with a coupling collar on each end. The coupling collar includes a free space on its inner circumferential surface at the end distal to the end face. A sealing body is arranged in the free space. The invention also relates to a method for securing a coupling collar to an end of the tubular body of a delivery pipe by adhesion. The method is characterized in that a sealing body is arranged on an outer circumferential surface of the tubular body, and an adhesive is applied upon the outer circumferential surface between the sealing body and an end face. The coupling collar or the tubular body is then caused to rotate about the longitudinal pipe axis, and the coupling collar is pushed over the end of the tubular body, or vice versa. The sealing body is finally pushed into a free space of the coupling collar.

The invention relates to a delivery pipe for the transport of solid material, with a tubular body which includes on each end a coupling collar being fixed by adhesion, and a method of realizing a securement of a coupling collar by adhesion to an end of the pipe body of the tubular body of a delivery pipe.

The transport of solids, like, for example of building material, concrete, pebbles, or sand, is implemented pneumatically or hydraulically in pipelines which are assembled from several interconnected delivery pipes. The ends of the delivery pipes are respectively coupled by coupling collars. The connection of the delivery pipes via the coupling collars is implemented either by coupling disks or by screw bolts, when the coupling collars are provided with bores.

Currently, delivery pipes are almost exclusively used with coupling collars that are welded to the tubular bodies. The heat impact during welding may however cause disadvantageous changes in structure in the connection zone of the delivery pipes.

DE 196 07 871 C2 discloses a conventional delivery pipe in which the coupling collars are glued to the outer surface of the pipe end across the entire area thereof. This approach is basically innovative because a disadvantageous heat impact is avoided in the jointing zone. Practice has shown however that problems have been more and more encountered as a result of leakage of such delivery pipes. The reason for that are tolerance differences between the tubular bodies and the coupling collars as well as the deficient quality of the glue connection. Damaged delivery pipes needed thus to be replaced, causing operational downtimes and a generally shorter service live.

Starting from this prior art, the invention is based on the object to provide a delivery pipe which is improved as far as use and service life are concerned, and to provide an improved method of making a delivery pipe.

The first part of the object is attained in accordance with the invention by a delivery pipe according to the features of claim 1.

The essence of the invention resides in the features to provide the coupling collar at the collar end which is distal to its end face and points toward the tubular body with a free space at its inner circumferential surface and to arrange in the free space a sealing body.

The free space facilitates the placement of the coupling collar when glued to the end of the tubular body. In particular, it is advantageous that the adhesive is able to slide or is drawn into the jointing gap between the coupling collar and the outer surface of the outer pipe at the end of the tubular body. A sharp edge which could shear off the adhesive is avoided.

The sealing body acts as barrier for the adhesive. The adhesive is held in this way in the jointing gap and an escape during the production process becomes much more difficult. The sealing body is made preferably of an elastomer or cellulose and has a round or rectangular cross section.

Advantageous configurations and further improvements of the principal nature of the invention are the subject matter of the dependent claims 2 to 9.

According to an advantageous configuration, the free space is constructed as a recess. Received in the recess is the sealing body without being compressed.

According to a further embodiment, a seal is arranged on the end face anteriorly of the ends of the tubular body for sealing the jointing gap between the tubular body and the coupling collar. The seal prevents an undermining of the glued coupling collar by transport fluid under pressure during operation. As a result, leakage is prevented in the area of the coupling collars. Bonding between coupling collar and the outer surface of the outer pipe is realized across part of the surface or across the entire surface and is tension-proof. Preferably, a multicomponent adhesive which hardens aerobically is used. Securement by adhesion of the coupling collar without heat impact eliminates disadvantageous changes in structure, hardness jumps, or brittleness in the material of the delivery pipe. Stress distribution in the area of the jointed connection is uniform. Overall, operating downtimes are reduced and the service life of the delivery pipe or of a pipeline composed of delivery pipes according to the invention is enhanced.

The seal may be implemented as a sealing ring or a sealing layer of suitable sealing material, for example from an elastomer. The adhesive itself may also assume a sealing function, when exhibiting sealing properties in addition to the adhesive properties, for ensuring a high-strength glue connection.

Especially beneficial in use is a configuration which involves the provision of a radially inwardly directed circumferential shoulder at the end face of a coupling collar. the seal is captured on the end face of the tubular body by this shoulder. This may, optionally, be implemented via interposition of a wearing ring.

The use of wearing rings at the ends of the tubular body has generally proven advantageous within the scope of the invention. The wearing rings are made of wear-resistant and shock-resistant material, for example of a ceramic wear-resistant material, cast chromium carbide, martensitic chill nickel casting (Ni-hard), or similar wear-resistant material. Preferably, a wearing ring is provided at least on the entry-side end of a delivery pipe.

The wearing ring is arranged in the area of the coupling collar. A seal may hereby be incorporated between the wearing ring and the end of the tubular body as well as between the shoulder and the wearing ring.

The delivery pipe according to the invention may have a single-layer as well as double-layer configuration. In its double-layer configuration, the delivery pipe includes a highly wear-resistant hardened inner pipe and a pressure-resistant outer pipe. The inner pipe of hardened steel is intended to provide a longest possible wear resistance to the solid being transported. Compared to the inner pipe, the outer pipe is softer and less impact-resistant. This is advantageous in particular with respect to the transport as well as assembly and disassembly because the delivery pipes are typically subjected to rough handling.

The outer pipe assumes the function of an envelope for protection against shock and impact. As a consequence, it is sufficient to configure the outer pipe thin-walled. Still, a reliable connection with the glued coupling collar is possible. Therefore, the invention enables the use of an inner pipe which is significantly thicker than the outer pipe, which fact also positively contributes to an increase of the service life of the delivery pipe.

The second part of the object is attained in accordance with the invention by a method of making a delivery pipe according to the features of claim 10.

An essential feature of the method is the positioning of a sealing body upon an outer circumferential surface of the tubular body. Subsequently, adhesive is applied upon the outer circumferential surface between the sealing body and an end face. Thereafter, the coupling collar or the tubular body is caused to rotate about the longitudinal pipe axis and the coupling collar is slipped over the end of the tubular body, or vice versa. Finally, the sealing body is pushed into the free space.

When positioning the sealing body, it should be taken into account that the distance between the sealing body and the end face is not sized too great in order to allow the sealing body to fulfill its function as barrier against the adhesive, when being slipped on. Ideally, the coupling collar impacts the sealing body when being slipped on and pushes the sealing body in front of it for a short distance.

Devices may be used to produce the rotary and/or translational movements of coupling collar and tubular body and to push the sealing body into the free space.

Exemplified embodiments of the invention will now be described in greater detail. It is shown in:

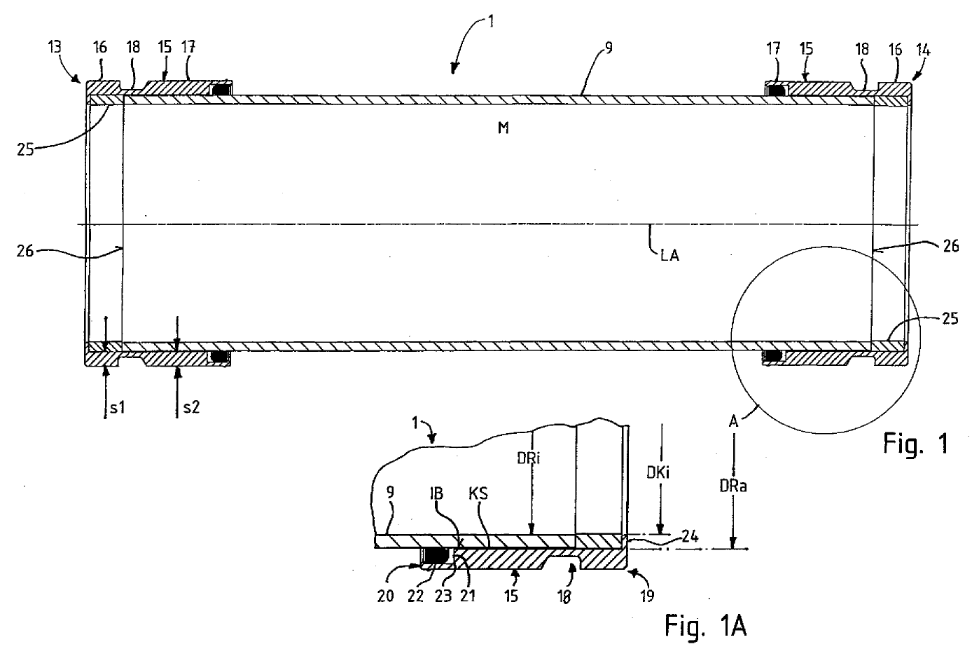

FIG. 1 a longitudinal section of a first embodiment of a delivery pipe according to the invention;

FIG. 1A an enlarged illustration of the area A of FIG. 1;

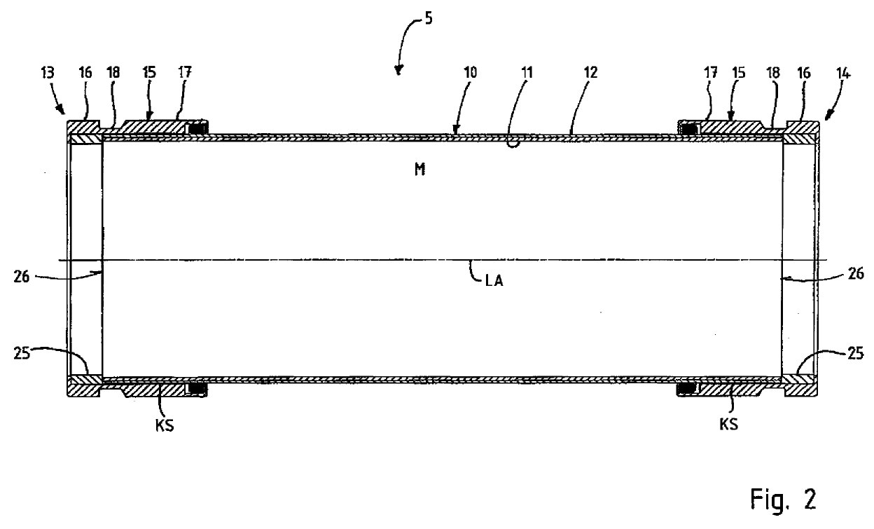

FIG. 2 a longitudinal section of a second embodiment of a delivery pipe according to the invention;

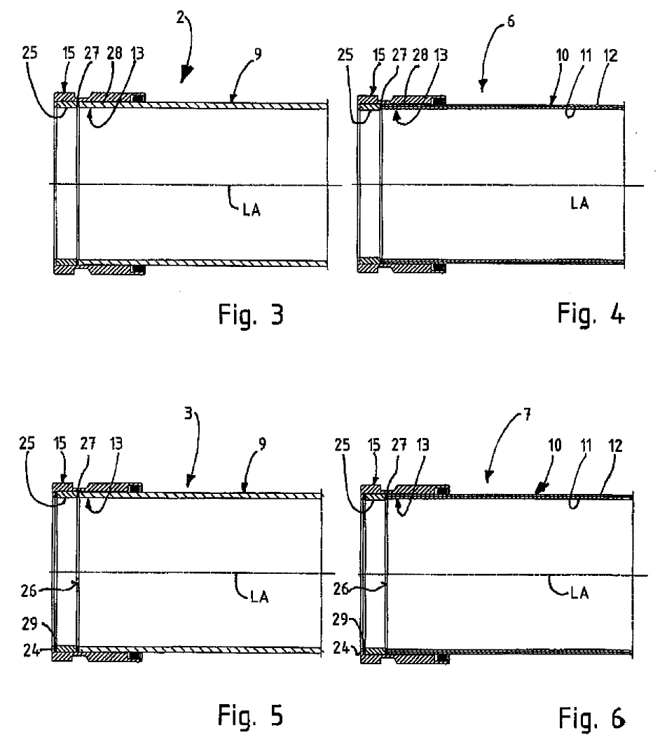

FIGS. 3 to 8 sectional views of an end portion of eight further embodiments of a delivery pipe according to the invention; and

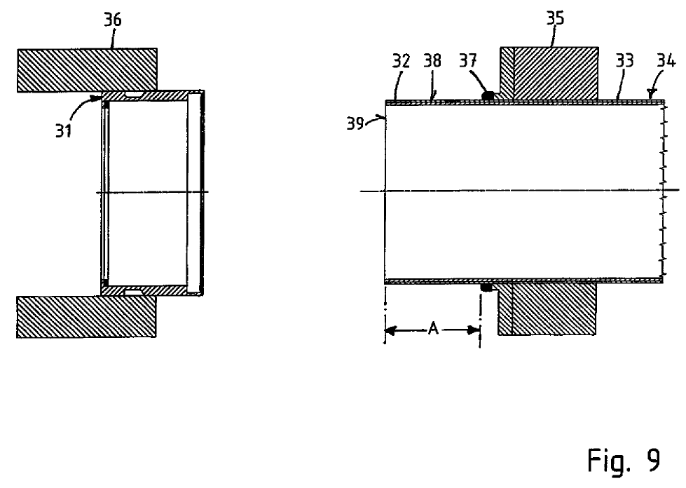

FIGS. 9 to 13 five sectional views for illustration of the method steps of making delivery pipes.

Same designations are used for corresponding parts in FIGS. 1 to 13.

FIGS. 1, 3, 5, and 7 show single-layer embodiments of a delivery pipe 1, 2, 3, 4, whereas FIGS. 2, 3, 6, and 8 show double-layer embodiments of delivery pipes 5, 6, 7, 8.

The delivery pipes 1, 2, 3, 4 have a single-layer tubular body 9 of highly wear-resistant hardened steel material. The delivery pipes 5, 6, 7, 8, on the other hand, are of double-layer configuration with a tubular body 10 comprised of a highly wear-resistant hardened inner pipe 11 and a pressure-resistant outer pipe 12.

A coupling collar 15 is secured on each end 13, 14 of the tubular body 9 and 10, respectively, by adhesion across the entire surface. As viewed in the direction of the longitudinal pipe axis LA, the coupling collar 15 includes a terminal 1^{st} collar section 16 and an inner 2^{nd} collar section 17 pointing in the direction of the pipe center M, with a trapezoidal coupling groove 18 disposed in-between. It can be seen that the wall thickness s1 of the 1^{st} collar section 16 is sized smaller than the wall thickness s2 of the 2^{nd} collar section 17. Unillustrated clamps engaging the coupling collars 15 are used for producing a pipeline by linking members of delivery pipes 1-8.

The representation of FIG. 1A shows that the coupling collar 15 is secured upon the tubular body by adhesion with an adhesive KS. On its end 20 distal to its end face 19, the coupling collar 15 has a free space 21 at its inner circumferential surface IB for arrangement of a sealing body 22 in the form of a sealing ring. The free space 21 is configured as recess 23.

Provided on the end face 19 of the coupling collar 15 is a radially inwardly directed circumferential shoulder 24, whereby the inner diameter DKI of the shoulder 24 corresponds to the inner diameter DRI of the tubular body 9 and 10, respectively. In any event, the inner diameter DKI is smaller than the outer diameter DRA of the tubular body 9, 10. The shoulder 24 forms a stop when a coupling collar 15 is slipped over the end 13 and 14, respectively, of a tubular body 9, 10.

In the embodiments of the delivery pipes 1 and 5 according to the illustrations of FIGS. 1 and 2, a wearing ring 25 is placed in the area of the coupling collar in front of the end face 26 of the tubular body 9, 10. The wearing ring 25 is glued to the coupling collar 15. On the end face, the wearing ring 25 is held by the shoulder 24 which rests against the wearing ring.

The embodiments of delivery pipes 2, 6 shown in FIGS. 3 and 4 have each a seal 27 which is additionally incorporated between the tubular body 9, 10 and the wearing ring 25. The seal 27 seals the tubular body 9, 10 against the coupling collar 15 so that fluid is prevented from escaping through the jointing gap 28.

Aiso the delivery pipes 3 and 7 (FIGS. 5 and 6, respectively) are equipped with a bonded wearing ring 25 which is incorporated between the shoulder 24 and the end 13, 14 of the tubular body 9, 10. A seal 27 is hereby arranged between the end face 26 of the tubular body 9, 10 and the wearing ring 25, and a seal 29 is arranged between the shoulder 24 and the wearing ring 25.

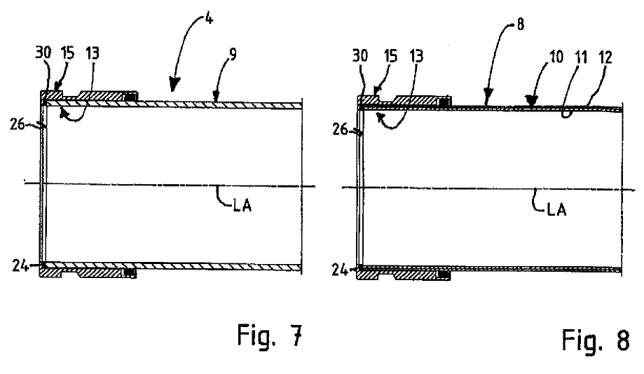

The delivery pipe 4 and 8 according to the illustrations in FIGS. 7 and 8, respectively, has arranged in front of the end faces 13, 14 of the tubular body 9 and 10, respectively, a seal 30 upon which the shoulder 24 of the coupling collar 15 rests so that the seal 30 is pressed against the end face 26 of the end 13 and 14, respectively.

The method according to the invention for making a delivery pipe is shown in greater detail in FIGS. 9 to 13. The aim is the production of a securement by adhesion of a coupling collar 31 to an end 32 of a double-layer tubular body 33 of a delivery pipe 34.

Initially, the tubular body 33 is clamped in a 1^{st} apparatus 35 and the coupling collar 31 is clamped in a 2^{nd} apparatus 36 (cf. FIG. 9). The sealing body 37 in the form of a sealing ring is then positioned on the outer circumferential surface 38 of the tubular body 33. Distance A between the sealing body 37 and an end face 39 of the tubular body 33 is just about large enough to enable the coupling collar 31 to impact later the sealing body 37 when being slipped on.

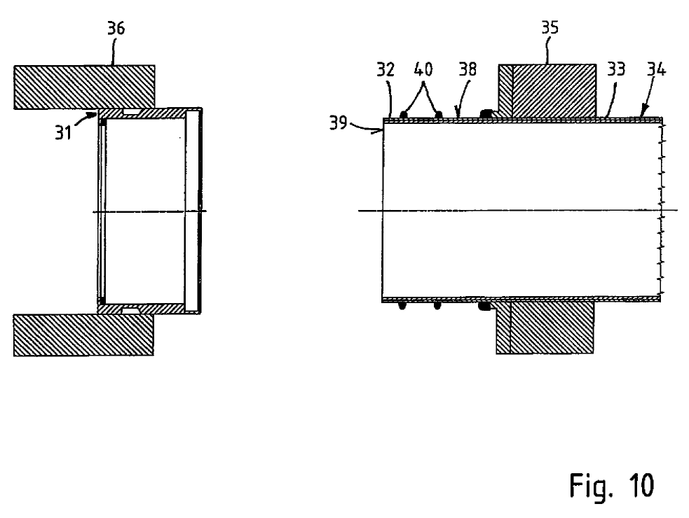

An adhesive 40 is applied in the second step (cf. FIG. 10) on the outer circumferential surface 38 of the tubular body 33. The adhesive 40 is hereby evenly distributed.

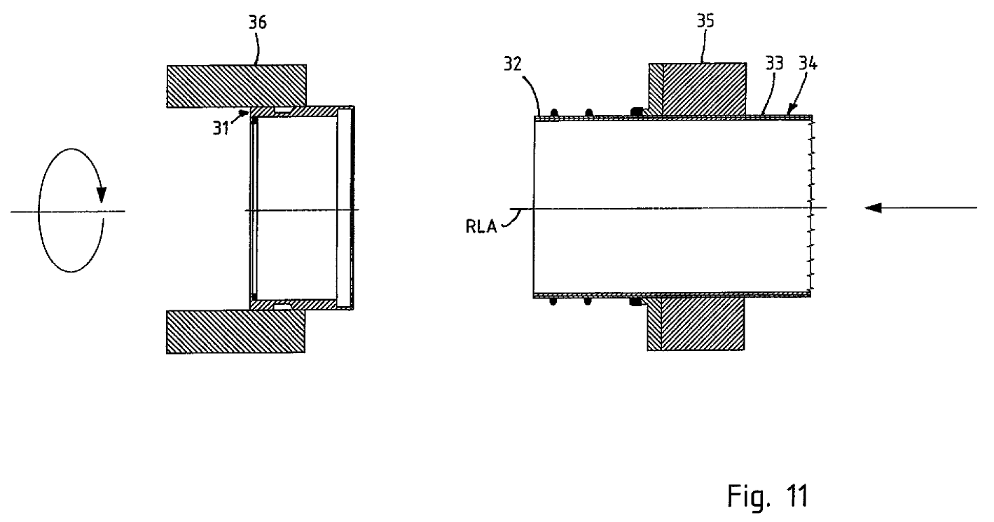

In the third step (cf. FIG. 11), the 2^{nd} apparatus 36 causes the coupling collar 31 to rotate about the longitudinal pipe axis RLA. The tubular body 33 is moved by the 1^{st} apparatus 35 in the direction of the coupling collar 31.

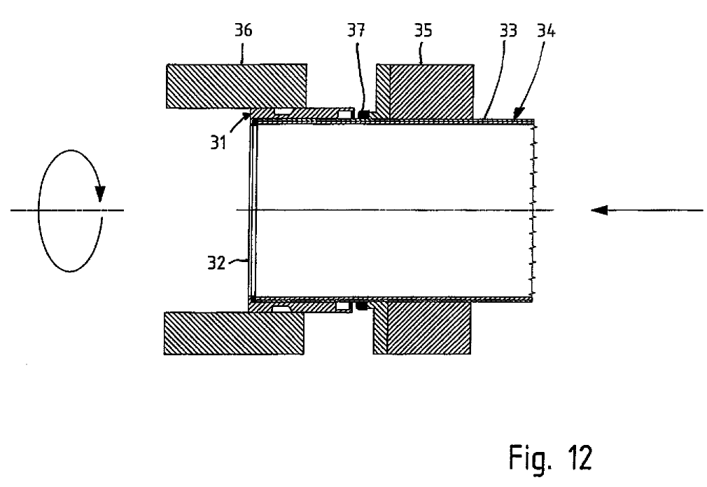

In the fourth step (cf. FIG. 12), the end 32 of the tubular body 33 is pushed into the coupling collar 31, while the coupling collar 31 continues to rotate.

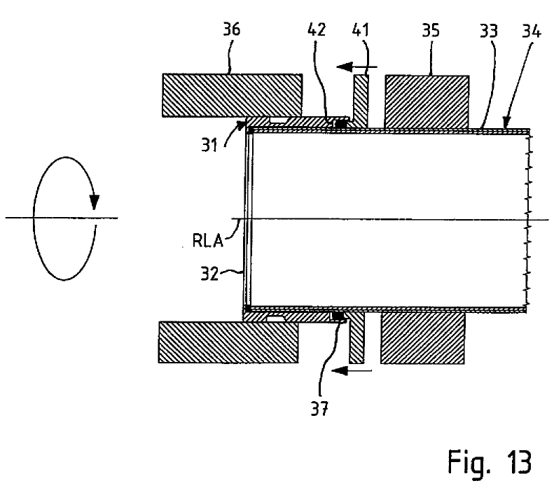

In the last operating step (cf. FIG. 13), the sealing body 37 is pushed by a slider 41 on the 1^{st} apparatus 35 into a free space 24. This is assisted by the continued rotation of the coupling collar 31.

### LIST OF REFERENCE SIGNS

1—delivery pipe
2—delivery pipe
3—delivery pipe
4—delivery pipe
5—delivery pipe
6—delivery pipe
7—delivery pipe
8—delivery pipe
9—tubular body
10—tubular body
11—inner pipe
12—outer pipe
13—end of 9, 10
14—end of 9, 10
15—coupling collar
16 —1^{st} collar section of 15
17—2^{nd} length section of 15
18—coupling groove
19—end face of 15
20—end
21—free space
22—sealing body
23—recess
24—shoulder
25—wearing ring
26—end face of 13, 14
27—seal
28—jointing gap
29—seal
30—seal
31—coupling collar
32—end of 33
33—tubular body
34—delivery pipe
35—1^{st} apparatus
36—2^{nd} apparatus
37—sealing body
38—outer circumferential surface of 33
30—end face of 33
40—adhesive
41—slider
42—free space
A—distance
DKi—inner diameter of 24
DRa—outer diameter of 9, 10
DRi—inner diameter of 9, 10
IB—inner circumferential surface of 15
LA—longitudinal axis of 1-8
RLA—longitudinal pipe axis of 34
s₁—wall thickness of 16
s₂ —wall thickness of 17

1-10. (canceled)

11. A delivery pipe for the transport of solid material, comprising:
a tubular body having opposite ends;
a coupling collar secured by adhesion to each end of the tubular body, wherein the coupling collar having an end face and an inner circumferential area configured to define a free space in the form of a recess in a region of an end that is distal to the end face; and
a sealing body in the form of a sealing ring arranged in the free space.

12. The delivery pipe of claim 11, further comprising a seal arranged at the end face of the coupling collar in front of the associated one of the ends of the tubular body.

13. The delivery pipe of claim 11, further comprising a radially inwardly directed circumferential shoulder at the end face of the coupling collar.

14. The delivery pipe of claim 13, further comprising a seal incorporated between the shoulder and the associated one of the ends of the tubular body.

15. The delivery pipe of claim 11, further comprising a wearing ring arranged in an area of the coupling collar.

16. The delivery pipe of claim 15, further comprising a radially inwardly directed circumferential shoulder at the end face of the coupling collar, wherein the wearing ring is incorporated between the shoulder and the associated one of the ends of the tubular body.

17. The delivery pipe of claim 16, further comprising a seal arranged between the shoulder and the wearing ring.

18. The delivery pipe of claim 11, wherein the tubular body has a double-layer configuration.

19. A method of securing a coupling collar to one end of a tubular body of a delivery pipe for the transport of solid material, comprising the steps of:
positioning a sealing body on an outer circumferential surface of the tubular body;
applying an adhesive on the outer circumferential surface of the tubular body between the sealing body and an end face of the tubular body;
causing a coupling collar or the tubular body to rotate about a longitudinal pipe axis;
pushing the coupling collar over the end of the tubular body, or vice versa; and
pushing the sealing body into a free space of the coupling collar.

20. A method of securing a coupling collar to one end of a tubular body, comprising the steps of:
positioning a coupling collar in confronting relationship to the one end of the tubular body
slipping a sealing body over the tubular body into a predetermined position of the tubular body;
applying an adhesive between the sealing body and the end of the tubular body;
rotating one member selected from the group consisting of coupling collar and tubular body;
moving the other member in relation to the one member so as to push the coupling collar over the end of the tubular body; and
pushing the sealing body into a free space of the coupling collar.

21. The method of claim 20, wherein the predetermined position of the sealing body is spaced from an end face of the tubular body by a distance which corresponds to an axial length of the coupling collar.
